(19) United States
(12) Patent Application Publication
(10) Pub. No.: US 2013/0056461 A1
(43) Pub. Date: Mar. 7, 2013

(54) METHOD AND APPLIANCE FOR REDUCING AND ELIMINATING LOCAL AREAS OF OVERHEATING IN SENSITIVE LOADS OF DIELECTRIC MATERIALS

(71) Applicants: Lars Ekemar, Gnesta (SE); Pierre Westin, Taby (SE)

(72) Inventors: Lars Ekemar, Gnesta (SE); Pierre Westin, Taby (SE)

(73) Assignee: Antrad Medical AB, Stockholm (SE)

(21) Appl. No.: 13/698,595

(22) PCT Filed: May 19, 2011
(86) PCT No.: PCT/SE2011/000087

§ 371 Date: Nov. 16, 2012

Related U.S. Application Data
(60) Provisional application No. 61/358,091, filed on Jun. 24, 2010.

(30) Foreign Application Priority Data
May 21, 2010 (SE) 1000546-0

(51) Int. Cl. H05B 6/00; H05B 6/62

(52) U.S. Cl. 219/774; 219/385; 219/438

(57) ABSTRACT

This invention is about a method and a device for equalizing warming processes in dielectric loads using electric/electromagnetic fields at frequencies below 900 MHz. Characteristic for the invention is that the load is surrounded by a field equalizing material and that the load and the electric/electromagnetic field is moved relative to each other.

### BACKGROUND OF THE INVENTION

It is known that electromagnetic fields can be used for thawing, warming and treating different loads consisting of dielectric materials. Examples of such dielectric materials are proteins, wood pulp, alcohols and salts dissolved in water. Examples of electromagnetic fields include microwaves, (frequencies above 900 MHz) and radio fields (frequencies below 900 Mhz). There are many examples of demanding medical and industrial applications requiring a fast and homogenous warming (i.e., even field distribution). One example is a bag with 250 ml frozen blood plasma intended for transfusion, another example is a bag of frozen stem cells, but it can also be about controlling different chemical processes such as the acetylating of wood.

A common problem of warming with microwaves is that the wavelength is short, at 2500 MHz, (the commercial microwave frequency) the wavelength is 12 cm in vacuum/air and in most dielectric loads the wavelength is 2-5 cm. At frequencies used regularly in microwave products hotspots are common due to reflection and interference. A high frequency will also result in development of superficial energy.

The energy development in a dielectric material is determined by following relationship.

W=ε′*tan(δ)*f*E²

Wherein W is the power, ε′ is the constant of dielectricity, tan(δ) is the loss factor, f is the frequency and E is the field strength.

A measure of the energy distribution is the penetration of depth which is defined by δ=c/π*f√ε*tan(δ) where c is the speed of light in vacuum.

In order to avoid hotspots as a result of reflection and interference and obtain a more homogenous warming process, a lower frequency can be applied. The wavelength in the load increases, as a result, the homogeneity of the warming process improves and the problems with so called hot spots are reduced and possibly eliminated.

If a longer wavelength (lower frequency) is applied, at unmodified power and dielectricity values, the field strength will increase compared with higher frequency. The power generation is a function of E², therefore a relatively small increase of the field strength at a lower frequency will result in a considerable increase of the power generation compared with higher frequencies.

At transitions between load and surrounding air; at corners/edges and protrusive parts, an increase of the field strength with correlating heat generation often appear. It depends on the wavelength: the longer the waves are, the easier the field lines will turn around corners/edges and protrusive parts with a correlating increase in field strength.

Warming a load with electromagnetic fields without any local overheating requires that the wavelength is long enough in relation to reflection and interference phenomena and that the turning around corners/edges and protrusive parts is reduced or preferably eliminated. It is favorable if this can be done without considerable energy losses.

At frequencies below 900 MHz the probability for distinct hotspots is reduced and at frequencies below 300 MHz it is negligible. At shorter wavelengths the energy is more concentrated at the extinction points compared with longer wavelengths. This is especially valid if the load has a large constant of dielectricity that will additionally shorten the wavelength. However, at longer wavelengths the problems with overheating increase due to the turning of the electromagnetic fields/field lines at corners, edges and protrusive parts.

In order to solve the problem with turning of field lines at protrusive parts different solutions have been suggested.

In patent UK 599,935 a dielectric load is placed in a liquid with the same constant of dielectricity and loss factor as the load that is being heated. If there is enough of the surrounding liquid local overheating is eliminated on/in the load. The disadvantage with this solution is that the major part of the energy is absorbed by the surrounding liquid resulting in a negative energy aspect. Further a controlled and repetitive warming process of a dielectric load is made more difficult because the temperature of the surrounding liquid is altered/changed due to accumulated energy absorption contributing to the warming of the load.

In patent WO 02/054833 the dielectric load is surrounded with a dielectric material having a dielectric constant similar to the dielectric constant of the load but the loss factor of the surrounding material is small compared with the loss factor of the load. In this patent the load of a blood fraction, for example frozen blood plasma intended for transfusion is stored in a PVC bag. In that way, the turning of the electromagnetic fields/field lines at corners, edges and protrusive parts is reduced as well as no energy is absorbed in the surrounding material.

It is difficult to obtain a solution with identical dielectric constants of the load and the surrounding material. Pockets of air may also appear between the load and the surrounding material/liquid that may cause concentration of the electric/electromagnetic field to certain areas that will result in parts of the dielectric load being warmer than others.

If the load consists of perishable materials such as blood fractions intended for transfusion local overheating can result in devastating consequences.

Other biological materials such as frozen stem cells, organs intended for transfusion, etc. for the same reasons, require a homogenous thawing/warming process.

There are other applications that will benefit from a fast and homogenous thawing and warming process. One application is frozen fish and meat used as raw material in food processing industry. These raw materials are usually stored in frozen 10 kg blocks and have to be thawed before processing. Because of hygienic reasons, the surface has to be kept cold; therefore such blocks of fish and meat are thawed slowly in cold-storage rooms. The slow thawing process generates considerable capital costs and requires considerable planning efforts in order to achieve a cost efficient production. The thawing of raw materials of fish and meat is costly.

### SUMMARY OF THE INVENTION

This invention solves the problems described above.

To master the problems with the previously described edge effects, the load and the surrounding dielectric material are exposed to an electric/electromagnetic field at frequencies below 900 MHz, still better below 300 MHz. The field is moved more or less continuously relative to the load. In this way zones in the load, with higher field strength, are moving around in the load and the risk for local overheating is eliminated. This can be accomplished in different ways.

A dielectric load is surrounded completely or partly by a dielectric material whose dielectricity constant is similar to the dielectricity constant of the load and with a small loss factor compared to the load. The load with the surrounding dielectric material is placed in an electric/electromagnetic field, for example between a pair of capacitors. Between the capacitors an alternating electric field is generated. By moving the load or parts of the load and the surrounding dielectric material within the electric/electromagnetic field, the field will chose different paths through the load and the surrounding dielectric material. The field strength in different parts of the load and surrounding dielectric material is altered dynamically and local field concentrations to small areas are avoided.

Alternatively only the load is moved relative to the electric/electromagnetic field and the surrounding dielectric material. The latter is possible if the load is a solid or a liquid within a container and the surrounding dielectric material is a liquid. In this way two different means contribute to a homogenous energy distribution. On one hand the load is moved relative to a field strength concentration within the load, on the other hand the field distribution is affected thus the field is moved relative to the load and surrounding dielectric material.

Alternatively the electric/electromagnetic field can be made to move relative to the load and surrounding dielectric material. It can be done by moving the capacitors meanwhile the load and surrounding is fixed. Thus the field distribution is moved relative to the load and surrounding material.

Overheating can be overcome using a combination of the steps found in the examples above.

It is also possible to place a dielectric load surrounded by a dielectric load according to previous examples. The load may consist of a solid material, a plastic and/or elastic material or a liquid within a container or a frozen material within a container thawing during a warming process. The surrounding dielectric material may be a liquid within some sort of containers/bags with flexible walls/sides. The load is placed in such way that it is completely or partly surrounded/in contact with such containers/bags filled with dielectric liquid. In its most simple form it can be a dielectric load placed between two bags/containers with flexible walls containing a dielectric liquid with required properties.

The load and the bags/containers are placed in an electric/electromagnetic field with one or several frequencies below 900 MHz and still better below 300 MHz. The electric/electromagnetic field is made moving in the load by mechanically deforming one or several of the bags surrounding the load. This moving of the field is a result of the law of refraction.

Deformation can be made in different ways. For example pegs going through holes in capacitors or cavity walls. The pegs can be designed in various ways. Between pegs and the field equalized material may be one or several plates, the pegs push on the plates and the plates push on the field equalized material. The pegs may be attached to the plates; the plates may also be an integrated part of the container/containers containing field equalized material.

Between the load and the field equalized material there may be one or several layers of one or several materials, for example the material containing the field equalizing material. Should the material/materials have an unfortunate combination of thickness, dielectricity constant, and loss factor, warm areas may appear. The law of refraction and the principle of field energy per unit and volume are crucial. The material and design are selected in such a way that the material enclosing the load and/or the field equalizing dielectric material is affected marginally.

If a layer/layers as above, in-between the load and field equalizing material, is/are relatively thick with a large constant of dielectricity, the electric field will tend to turn and refract which may cause local heat in some areas. This is particularly a problem if the layer/layers between the load and the field equalizing material are thick and have a large dielectricity constant in relationship to applied wavelength in vacuum. If the loss factor/factors of the material/materials, the layer/layers between the load and the field equalizing material are large it is a risk for local overheating in the above mentioned layer/layers.

To assure no overheating in the layer/layers in-between the load and equalizing material occurs the thickness of the layer/layers shall be less than 1% of applied wavelength in vacuum, still better 0.5% of applied wavelength in vacuum and best of all 0.1% of applied wavelength in vacuum and a constant of dielectricity/dielectricities in vacuum below 200% of the average dielectricity constant of the load, better 100% of the dielectricity constant of the load, still better 50% of the average loss factor of the load and preferably 25% of the average loss factor of the load.

To make sure a container with field equalizing material has made good contact with the load it is completely or partly made of a flexible material and the flexible parts of the container are in contact with the load. The flexible material may not be too thick as well as the modulus of elasticity and tensile strength is favorable. The flexible material in contact with the load shall have a thickness less than 5 mm, still better less than 3 mm and preferably below 1 mm and a modulus of elasticity at 20 shall be in the interval 0.05-4 GPa, still better 0.1-3 GPa and preferably 0.2-2 GPa and a tensile strength shall be within the interval 1-200 MPa, still better 2-100 MPa and preferably 6-80 MPa.

Different loads have very different shapes, even if the flexible material in-between the load and the equalizing material are thin and easy to shape. Minor spaces of air may appear between load and the flexible material.

It is favorable to choose the thickness and material properties of the flexible material in such a way that the cubic root of the space volume during the entire thawing/warming process is below 4% of shortest applied wavelength, better 2% of shortest applied wavelength, still better 1% of shortest applied wavelength and preferably 0.5% of shortest applied wavelength.

A load (for example frozen blood plasma) with surrounding field equalizing material is placed in a cavity equipped with an antenna/applicator. The antenna/applicator generates an electromagnetic field below 900 MHz, alternatively below 300 MHz. The load with field equalizing material is placed between applicator/antenna and cavity walls. The equalizing material consists of one or more liquids within one or more flexible or partly flexible container/containers surrounding the load completely or partly. The equalizing material may consist of de-ionized water within bags made of polyethylene.

The deformation of the containers/bags with dielectric material surrounding the load partly or completely is done mechanically; the containers with dielectric material are deformed utilizing pressure on one or more spots/areas. Thus the electric/electromagnetic field will move within the load and overheating is avoided. The bags/containers will be deformed one or several times during the warming process. Practically this is done that one or several pegs are going through one or several holes in the cavity. These rods are pushed alternately in and out of the cavity. In order to avoid possible leakage of electric/electromagnetic radiation the longest distance between two opposite points within the holes are smaller than 5% still better 2% and preferably 1% of applied wavelength in vacuum corresponding to the lowest applied frequency.

Alternatively the load with surrounding dielectric material can be placed between capacitors within a shielding case. The holes in the case correspond to the holes in the cavity above.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It should also be understood that the invention disclosed and defined herein extends to all alternative combinations of two or more of the individual features mentioned or evident from the text and/or the drawings. All of these different combinations constitute various alternative aspects of the present invention. The embodiments described herein explain the best modes known for practicing the invention and will enable others skilled in the art to utilize the invention.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

1. An appliance for reducing overheating of areas in a dielectric load placed in an electric/electromagnetic field at one or several frequencies below 900 MHz characterized by that the dielectric load is surrounded completely or partly by one or several dielectric material and that the a equalization of heat in the load is obtained by moving the load or a part/parts of the load and the electric/electromagnetic field relative to each other.

2. An appliance according to claim 1 characterized by the electric/electromagnetic field is moved relative the dielectric load by mechanically affect/deform the surrounding dielectric material.

3. An appliance according to claim 1 characterized by only the dielectric load placed in the surrounding dielectric material is moved relative the electric/electromagnetic field and surrounding dielectric material.

4. An appliance according to claim 1 characterized by the surrounding electric/electromagnetic field is moved relative the dielectric load and the surrounding dielectric material

5. An appliance according to claim 1 characterized by the dielectric load and the surrounding dielectric material is moved relative the surrounding electric/electromagnetic field.

6. An appliance according to claim 1 characterized by the dielectric load is completely or partly surrounded and physically in contact with containers with walls made of flexible or partly made of flexible material and the electric/electromagnetic field is moved relative the load by mechanically affect/deform one or several of surrounding containers containing dielectric liquid.

7. An appliance according to claim 1, wherein the dielectric load including surrounding dielectric material is placed in the electric/electromagnetic field in a cavity alternatively in a field generated between two capacitors with at least one hole in the cavity walls or in a shielding cage surrounding the two capacitors characterized by one or several pegs are going through the at least one hole in the cavity or the shielding cage deforming during a warming process one or several times the surrounding dielectric material.

8. A device for reducing overheating of areas in a dielectric load placed in an electric/electromagnetic field at one or several frequencies below 900 MHz, the dielectric load consists of one or several dielectric materials and is surrounded completely or partly by one or several dielectric materials, the load and the surrounding matters is placed in a cavity equipped with an antenna/applicator alternatively between a pair of capacitors placed in a shielding cage characterized by that the dielectric material surrounding the dielectric load is deformed one or several times during a warming process.

9. Device according to claim 8 characterized by that the surrounding dielectric material is partly or completely a one or more liquids within flexible or partly flexible containers.

10. Device according to claim 8 characterized by that the dielectric load is completely or partly surrounded and completely or partly in contact with containers equipped with flexible or partly flexible walls and the electric/electromagnetic field is moved relative the dielectric load by mechanically affect/deform one or several of the surrounding containers containing dielectric liquid.

11. Device according to claim 8, wherein the dielectric load is placed in the electric/electromagnetic field in a cavity alternatively in a field generated between two capacitors with at least one hole in the cavity walls or in the shielding cage surrounding the two capacitors characterized by one or several pegs are going through the at least one hole in the cavity or the shielding cage deforming during the warming process the surrounding dielectric material one or several times.
